(19) United States
(12) Patent Application Publication
(10) Pub. No.: US 2012/0280672 A1
(43) Pub. Date: Nov. 8, 2012

(54) POWER SUPPLY CIRCUIT FOR UNIVERSAL SERIAL BUS PORT

(75) Inventor: LI-YONG WANG, Wuhan (CN)

(73) Assignees: HON HAI PRECISION INDUSTRY CO., LTD., Tu-Cheng (TW); HONG FU JIN PRECISION INDUSTRY (WUHAN) CO., LTD., Wuhan City (CN)

(21) Appl. No.: 13/217,288

(22) Filed: Aug. 25, 2011

(30) Foreign Application Priority Data
May 5, 2011 (CN) 201110115474.7

(51) Int. Cl. G05F 3/08

(52) U.S. Cl. 323/304

(57) ABSTRACT

A power supply circuit for Universal Serial Bus (USB) ports includes a first USB port and a current amplifier circuit electrically connected to the first USB port. The first power converter receives a first voltage and outputs a first current. The second power converter receives the first voltage and outputs a second current. The first power converter and the second power converter are electrically connected together. The first current is output to the first USB port together with the second current.

### BACKGROUND

1. Technical Field

The present disclosure relates to power supply circuits, and particularly to a power supply circuit for providing power supply to a Universal Serial Bus (USB) port.

2. Description of Related Art

Universal Serial Bus (USB) is an industry standard developed in the mid-1990s that defines the cables, connectors and protocols used for connection, communication and power supply between computers and electronic devices. The USB 1.1 specification and the USB 2.0 specification are two kinds of popular specifications that are widely used in communication. Typically, a USB 2.0 specification port can provide a maximum current of 500 milliamperes. However, when a peripheral device that needs a current exceeding 500 milliamperes is connected to the USB 2.0 port, normal operation of the USB 2.0 port and/or the device will not achieved.

Therefore there is a need for improvement in the art.

### BRIEF DESCRIPTION OF THE DRAWINGS

FIG. 1 is a block view of a first embodiment of a USB port power supply circuit.

FIG. 2 is a circuit diagram of the USB port power supply circuit of FIG. 1.

FIG. 3 is a block view of a second embodiment of a USB port power supply circuit.

FIG. 4 is a circuit diagram of the USB port power supply circuit of FIG. 3.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

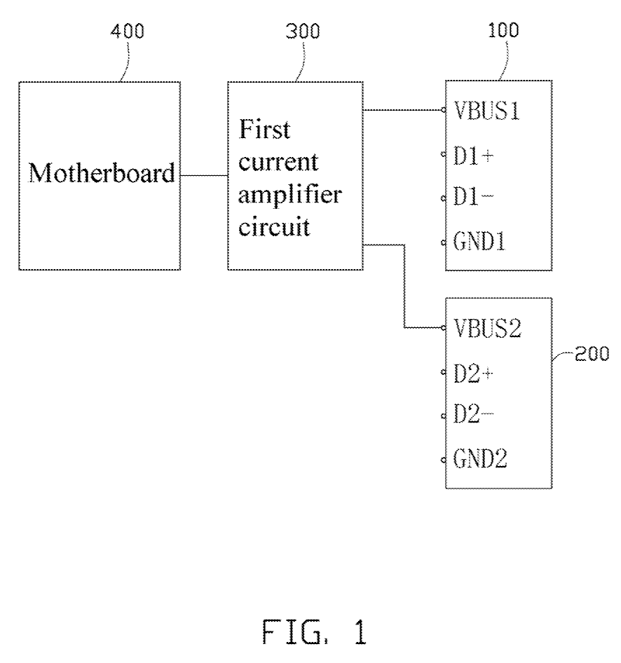

Referring to FIG. 1, a Universal Serial Bus (USB) port power supply circuit for providing power supply to a first USB port 100 and a second USB port 200, includes a first current amplifier circuit 300.

The first USB port 100 includes a first power terminal VBUS1, a first data receiving power input terminal D1+, a first data receiving ground input terminal D1− and a first ground terminal GND1. The second USB port 200 includes a second power terminal VBUS2, a second data receiving power input terminal D2+, a second data receiving ground input terminal D2− and a second ground terminal GND2. The first power terminal VBUS1 and the second power terminal VBUS2 receive a first voltage from a motherboard 400 via the first current amplifier circuit 300.

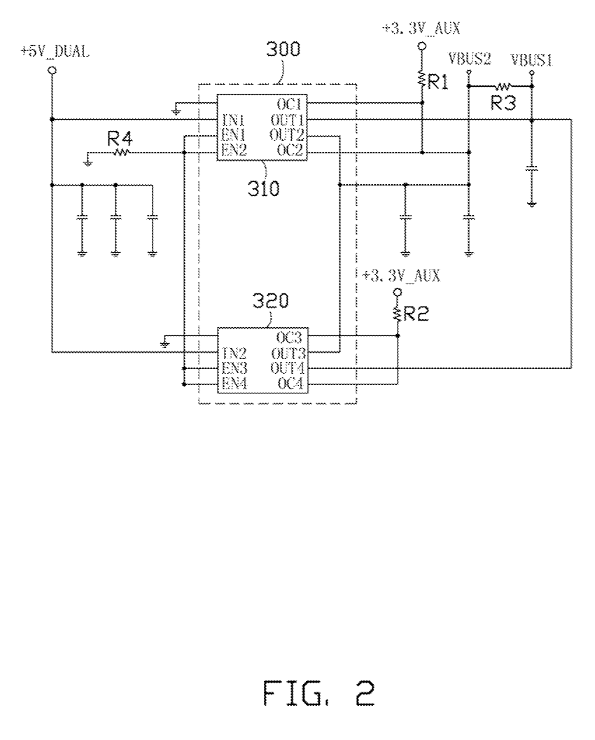

Referring to FIG. 2, the first current amplifier circuit 300 includes a first power converter 310 and a second power converter 320. The first power converter 310 and the second power converter 320 receive the first voltage and output a first current and a second current to provide power supply to the first USB port 100 and the second USB port 200.

The first power converter 310 includes a first input terminal IN1, a first enabled terminal EN1, a second enabled terminal EN2, a first power terminal OC1, a second power terminal OC2, a first output terminal OUT1, and a second output terminal OUT2. The second power converter 320 includes a second input terminal IN2, a third enabled terminal EN3, a fourth enabled terminal EN4, a third power terminal OC3, a fourth power terminal OC4, a third output terminal OUT3, and a fourth output terminal OUT4.

The first input terminal IN1 and the second input terminal IN2 receive the first voltage. The first power terminal OC1 and the second power terminal OC2 are electrically connected together to receive a second voltage via a first resistor R1. The third power terminal OC3 and the fourth power terminal OC4 are electrically connected together to receive the second voltage via a second resistor R2. The first power terminal VBUS1 is electrically connected to the second power terminal VBUS2 via a third resistor R3. The first enabled terminal EN1, the second enabled terminal EN2, the third enabled terminal EN3, and the fourth enabled terminal EN4 are electrically connected together and grounded via a fourth resistor R4. The first output terminal OUT1 and the fourth output terminal OUT4 are electrically connected together to output the first current to the VBUS1. The second output terminal OUT2 and the third output terminal OUT3 are electrically connected together to output the second current to the second power terminal VBUS2. In one embodiment, the first voltage is a +5 volts bidirectional voltage; and the second voltage is a +3.3 volts auxiliary voltage. A resistance of the third resistor R3 is zero ohms; and a resistance of the fourth resistor R4 is zero ohms

A range of current that can be output at the first output terminal OUT1 and the second output terminal OUT2 is 500 milliamperes to 1 ampere. A range of currents that can be output at the third output terminal OUT3 and the fourth output terminal OUT4 is 500 milliamperes to 1 ampere. Therefore, a range of the first current output by the first output terminal OUT1 and the fourth output terminal OUT4 is 1 ampere to 2 amperes; and a range of the second current output by the second output terminal OUT2 and the third output terminal OUT3 is 1 ampere to 2 amperes. Thus, the first USB port 100 and the second USB port 200 can function normally even when a peripheral device needing a current up to 2 amperes is connected to the first USB port 100 or the second USB port 200.

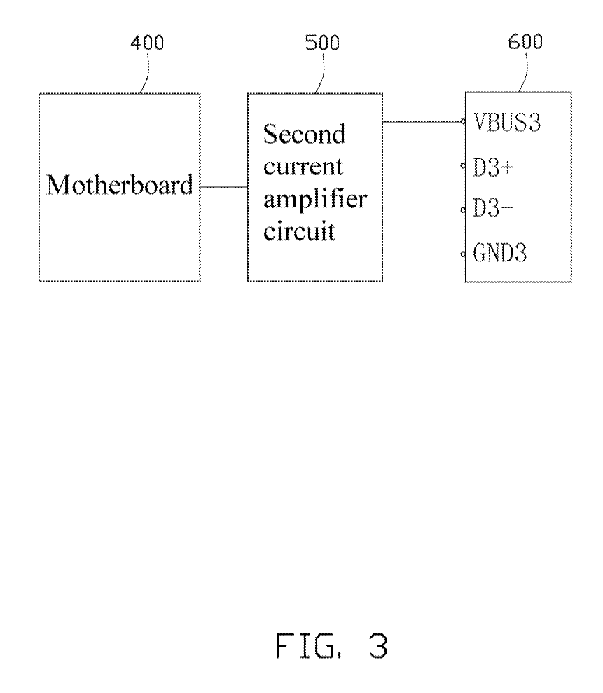

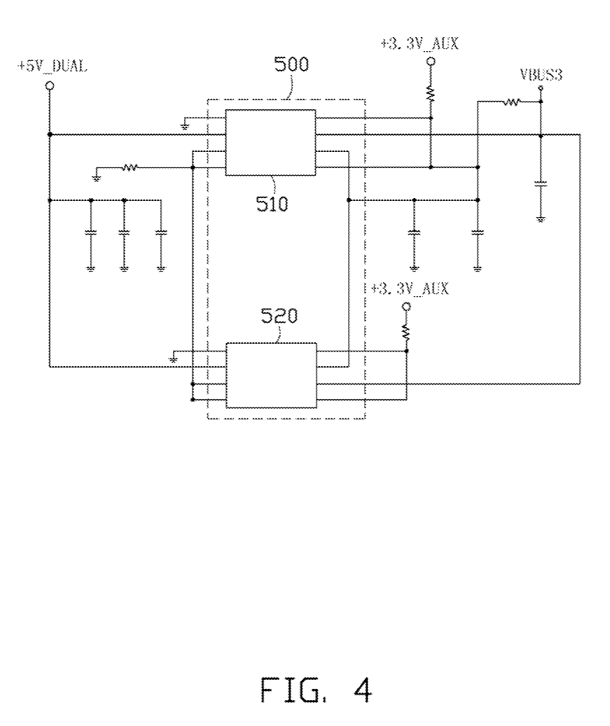

Referring to FIGS. 3 and 4, a second embodiment of a USB port power supply circuit includes a second current amplifier circuit 500. The second current amplifier circuit 500 has a similar circuitry as the first current amplifier circuit 300 and includes a third power converter 510 and a fourth power converter 520. The difference is that the third power converter 510 and the fourth power converter 520 provide power supply to a third power terminal VBUS3 of a single third USB port 600. A range of current that can be output at the third power converter 510 and the fourth power converter 520 is 500 milliamperes to 1 ampere each. Therefore, a range of current that can be output by the second current amplifier circuit 500 is 2 amperes to 4 amperes. Thus, the third USB port 600 can function normally even when a peripheral device which needs a current of up to 4 amperes is connected to the third USB port 600.

Even though numerous characteristics and advantages of the present disclosure have been set forth in the foregoing description, together with details of the structure and function of the disclosure, the disclosure is illustrative only, and changes may be made in detail, especially in matters of shape, size, and the arrangement of parts within the principles of the disclosure to the full extent indicated by the broad general meaning of the terms in which the appended claims are expressed.

What is claimed is:

1. A power supply circuit for Universal Serial Bus (USB) ports, comprising:
a first USB port; and
a current amplifier circuit electrically connected to the first USB port, the current amplifier circuit comprising:
a first power converter configured to receive a first voltage and output a first current; and
a second power converter configured to receive the first voltage and output a second current; wherein the first power converter and the second power converter are electrically connected together; and the first current is output to the first USB port together with the second current.

2. The power supply circuit of claim 1, wherein the first power converter comprises a first input terminal; the second power converter comprises a second input terminal; and the first input terminal and the second input terminal are configured to receive the first voltage.

3. The power supply circuit of claim 2, wherein the first power converter further comprises a first power terminal and a second power terminal; the second power converter further comprises a third power terminal and a fourth power terminal; the first power terminal and the second power terminal are electrically connected together to receive a second voltage via a first resistor; and the third power terminal and the fourth power terminal are electrically connected together to receive the second voltage via a second resistor.

4. The power supply circuit of claim 3, wherein the first voltage is a +5 volts bidirectional voltage; and the second voltage is a +3.3 volts auxiliary voltage.

5. The power supply circuit of claim 4, wherein the first power converter further comprises a first output terminal and a second output terminal; the second power converter further comprises a third output terminal and a fourth output terminal; the first output terminal and the fourth output terminal are electrically connected together to output the first current; and the second output terminal and the third output terminal are electrically connected together to output the second current.

6. The power supply circuit of claim 5, further comprising a second USB port; wherein the first output terminal and the fourth output terminal are electrically connected to the first USB port; and the second output terminal and the third output terminal are electrically connected to the second USB port.

7. The power supply circuit of claim 6, wherein the first USB port is electrically connected to the second USB port via a third resistor.

8. The power supply circuit of claim 7, wherein the first power converter further comprises a first enabled terminal and a second enabled terminal; the second power converter further comprises a third enabled terminal and a fourth enabled terminal; and the first enabled terminal; the second enabled terminal, the third enabled terminal and the fourth enabled terminal are electrically connected together and grounded via a fourth resistor.

9. The power supply circuit of claim 8, wherein a resistance of the third resistor is zero ohm; and a resistance of the fourth resistor is zero ohm.

10. A power supply circuit for Universal Serial Bus (USB) ports, comprising:
a first USB port; and
a current amplifier circuit electrically connected to the first USB port, the current amplifier circuit comprising:
a first power converter comprising a first input terminal, a first output terminal and a second output terminal; wherein the first input terminal is configured to receive a first voltage; and
a second power converter comprising a second input terminal, a third output terminal and a fourth output terminal; wherein the second input terminal is configured to receive the first voltage; the first output terminal and the fourth output terminal are electrically connected together to output a first current; the second output terminal and the third output terminal are electrically connected together to output a second current;
and the first current is output to the first USB port together with the second current.

11. The power supply circuit of claim 10, wherein the first power converter further comprises a first power terminal and a second power terminal; the second power converter further comprises a third power terminal and a fourth power terminal; the first power terminal and the second power terminal are electrically connected together to receive a second voltage via a first resistor; and the third power terminal and the fourth power terminal are electrically connected together to receive the second voltage via a second resistor.

12. The power supply circuit of claim 11, wherein the first voltage is a +5 volts bidirectional voltage; and the second voltage is a +3.3 volts auxiliary voltage.

13. The power supply circuit of claim 10, further comprising a second USB port;
wherein the first output terminal and the fourth output terminal are electrically connected to the first USB port; and the second output terminal and the third output terminal are electrically connected to the second USB port.

14. The power supply circuit of claim 13, wherein the first USB port is electrically connected to the second USB port via a third resistor.

15. The power supply circuit of claim 14, wherein the first power converter further comprises a first enabled terminal and a second enabled terminal; the second power converter further comprises a third enabled terminal and a fourth enabled terminal; and
the first enabled terminal; the second enabled terminal, the third enabled terminal and the fourth enabled terminal are electrically connected together and grounded via a fourth resistor.

16. The power supply circuit of claim 15, wherein a resistance of the third resistor is zero ohms; and a resistance of the fourth resistor is zero ohms.
